(19) United States
(12) Patent Application Publication
(10) Pub. No.: US 2025/0085410 A1
(43) Pub. Date: Mar. 13, 2025

(54) SENSING MANAGEMENT FUNCTION SENSING DIRECTION INDICATION

(71) Applicant: QUALCOMM Incorporated, San Diego, CA (US)

(72) Inventors: Preeti KUMARI, San Diego, CA (US); Hong CHENG, Basking Ridge, NJ (US); Kapil GULATI, Belle Mead, NJ (US); Junyi LI, Fairless Hills, PA (US); Shuanshuan WU, San Diego, CA (US)

(21) Appl. No.: 18/464,054

(22) Filed: Sep. 8, 2023

(51) Int. Cl. G01S 13/04

(52) U.S. Cl. CPC G01S 13/04

(57) ABSTRACT

A user equipment (UE) and related techniques are disclosed. In one aspect, the UE provides, to one or more wireless nodes of a radio access network (NG-RAN) associated with the core network or a second network entity of the core network different from the first entity, an indication of sensing directions for transmitting and receiving a radar signal to sense an environment of the apparatus. Latency may be reduced for tracking targets by skipping exhaustive scanning or complex full processing by exploiting prior sensing measurement reports collected by a sensing management function (SnMF). In this way, interference may be reduced and less resource and power usage may be enabled for sensing functions. In one case, sensing directions can be indicated in GCS and translated to a respective sensors' beam direction in LCS at NG-RAN or UE for efficient beam management. In one case, SnMF indicates a sensing direction in LCS to NG-RAN or UE for sensing signal transmission and/or reception.

### BACKGROUND

### Technical Field

The present disclosure generally relates to wireless communication systems, and more particularly, to architecture options for cooperative sensing and positioning.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

For example, some aspects of wireless communication include direct communication between devices, such as device-to-device (D2D), vehicle-to-everything (V2X), and the like. In addition, may be a variety of different devices such as user equipment (UEs), gNodeB (gNBs), or non-3rd Generation Partnership Project (3GPP) radar sensors. However, unlike radio access network (RAN), a core network may not manage beams across the different beam configurations to support sensing services. Thus, there exists a need for further improvements in such beam management across different types of sensing devices. Improvements related to direct communication between devices may be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a first user equipment (UE) configured to provide, to one or more wireless nodes of a radio access network (NG-RAN) associated with a core network or a second network entity of the core network different from a first entity, an indication of sensing directions for transmitting and receiving a radar signal to sense an environment of the apparatus.

In an aspect of the disclosure, a method, a computer-readable medium, and an apparatus are provided. The apparatus may be a NG-RAN configured to obtain, from a network entity of a core network associated with the NG-RAN, an indication of sensing directions in global coordinate system (GCS) for transmitting and receiving a radar signal to sense an environment of the apparatus. The apparatus is further configured to determine a beam configuration in a local coordinate system (LCS) based on the indication of sensing directions in the GCS.

In an aspect of the disclosure, a method, a computer-readable medium, and an apparatus are provided. The apparatus may be a second UE configured to obtain, from a second network entity of a core network associated with a NG-RAN, an indication of sensing directions in GCS for transmitting and receiving a radar signal to sense an environment of the apparatus. The apparatus may also be configured to determine beam configuration locally based on the indication of sensing directions for transmitting and receiving a radar signal to sense an environment of the apparatus. The apparatus may further be configured to transmit the radar signal in the beam configuration.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 is a diagram illustrating an example of an UE positioning overall diagram of the communication system, in accordance with various aspects of the present disclosure.

FIG. 5 is a diagram illustrating a passive localization configuration.

FIG. 6 is a block diagram of an example application device.

FIG. 7 is a block diagram of an example sensing management function.

FIG. 8 is a diagram illustrating an example of a wireless communications system that supports architecture options for cooperative sensing and positioning, in accordance with various aspects of the present disclosure.

FIG. 9 is an example of an UE positioning overall diagram of the communication system, in accordance with various aspects of the present disclosure.

FIG. 10 is a diagram illustrating a call flow between a base station, AMF, SnMF, and UEs.

FIG. 12 is a flowchart of a method of wireless communication at a first UE.

FIG. 13 is a flowchart of a method of wireless communication at a first UE.

FIG. 14 is a flowchart of a method of wireless communication at a first UE.

FIG. 15 is a flowchart of a method of wireless communication at a NG-RAN.

FIG. 16 is a diagram illustrating an example of a hardware implementation for an example apparatus.

FIG. 17 is a diagram illustrating another example of a hardware implementation for an example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

In some aspects of wireless communication, radar-based sensing may provide information about obstacles and/or objects in an environment. For example, a base station may have a radar component that transmits a radar signal and monitors for reflections of the radar signal that indicate the presence of a physical object or other information about the surrounding environment. The base station may use the information to adjust one or more parameters for wireless communication. In some aspects, radar measurements form at least one radar-capable device (e.g., a user equipment (UE), a base station, etc.) may provide information about a region in a line-of-sight (LoS) associated with the radar-capable device. LoS may refer to regions that receive an unobstructed signal from the radar device. In some aspects, being aware of the environment outside the region in the LoS associated with a particular radar-capable device (or a network node) responsible for aggregating radar measurement information received from a set of additional radar devices (e.g., associated with a JCR system), may allow the particular radar-capable device (or the network node) to find available beam directions that may reach a vehicle or other UE.

A joint communication radar (JCR) system integrates radar and wireless communication functionalities using shared hardware and signal processing modules and, in some aspects, sharing transmitted signals. JCR systems may provide for reception, at a first radar device, of radar measurement information from a set of additional radar devices to improve an environment mapping through a collaborative radar measurement application that combines radar information from different perspectives (e.g., from different devices) within a wireless communication system.

Vehicle UEs may need to sense surrounding objects for automotive applications, such as collision avoidance. To enable UE side JCR sensing. UL resources can be used for sensing. The UL resources may be shared between communication and radar modes. In addition, the UL resources may be separate resources for communication or radar such as using time-division multiplexing (TDM) mode or the UL resources can be the same resource for communication and radar with a joint co-design waveform.

For sensing service, there is a need for beam management across different sensing devices (e.g., UEs, gNBs, or non-3GPP radar sensors) to reduce interference, reduce latency for tracking targets, and enable less resource/power usage for sensing to reduce sensing congestion and increased communication preference (e.g., when JCR is implemented using resource/power sharing between sensing and communication). However, unlike RAN, core networks do not currently understand beam configuration. Thus, the current design principle does not allow the core network to manage the beam in a way needed to support sensing services.

Accordingly, aspects presented herein provide for improved wireless communication through utilizing a sensing management function (SnMF) in the core network to indicate sensing directions to different sensors directly via NG-RAN.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

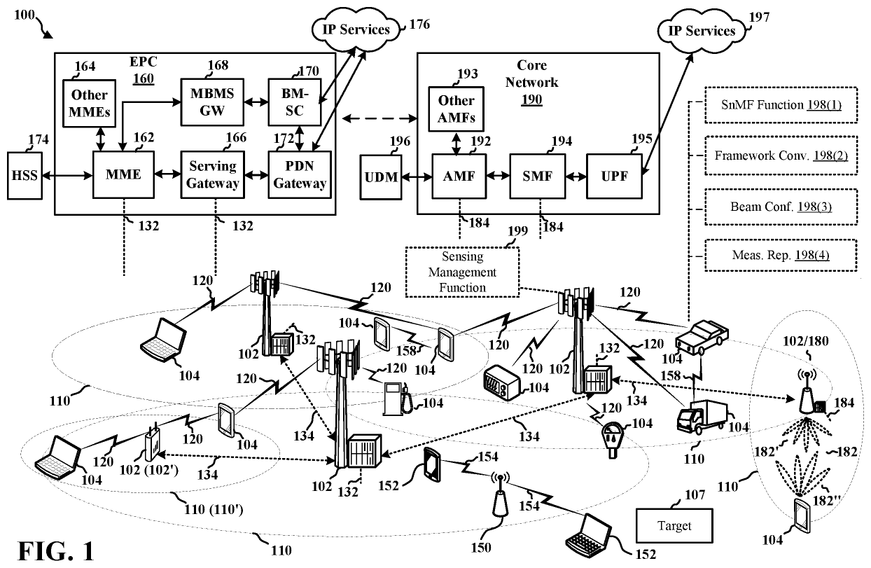

FIG. 1 is a diagram illustrating an example of a wireless communications system and an access network 100 in which base stations 102 or 180 may wirelessly communicate with user equipment (UEs) 104. The wireless communications system (also referred to as a wireless wide area network (WWAN)) includes base stations 102, user equipment(s) (UE) 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

Some wireless devices may perform radar signal sensing. For example, a radar device on a UE may transmit a wireless signal and use information about the signal to image an environment or determine information about a target 107 based on range, doppler, and/or angle information determined from the wireless signal.

The base stations 102 configured for 4G Long Term Evolution (LTE) (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G New Radio (NR) (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, Multimedia Broadcast Multicast Service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y megahertz (MHz) (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 gigahertz (GHz) unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHZ, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHZ-52.6 GHZ). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same. Although beamformed signals are illustrated between UE 104 and base station 102/180, aspects of beamforming may similarly be applied by UE 104 or RSU to communicate with another UE 104 or RSU, such as based on V2X. V2V, or D2D communication.

The EPC 160 may include a Mobility Management Entity (MME) 162, other MMEs 164, a Serving Gateway 166, an MBMS Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides Quality of Service (QOS) flow and session management. All user IP packets are transferred through the UPF 195. The UPF 195 provides UE IP address allocation as well as other functions. The UPF 195 is connected to the IP Services 197. The IP Services 197 may include the Internet, an intranet, an IMS, a Packet Switch (PS) Streaming Service, and/or other IP services.

The base station may include and/or be referred to as a gNB, Node B, cNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Referring again to FIG. 1, in certain aspects, the base station 180 may be configured to include a sensing management function (SnMF) component 199. The SnMF component 199 may be configured to obtain an indication of sensing directions in a global coordinate system (GCS) for transmitting and receiving a radar signal to sense an environment of the apparatus.

Some wireless communication networks may include vehicle-based communication devices that can communicate from vehicle-to-vehicle (V2V), vehicle-to-infrastructure (V2I) (e.g., from the vehicle-based communication device to road infrastructure nodes such as a Road Side Unit (RSU)), vehicle-to-network (V2N) (e.g., from the vehicle-based communication device to one or more network nodes, such as a base station), and/or a combination thereof and/or with other devices, which can be collectively referred to as vehicle-to-anything (V2X) communications. Referring again to FIG. 1, in certain aspects, a UE 104, e.g., a transmitting VUE or other UE, may be configured to transmit messages directly to another UE 104. The communication may be based on V2V/V2X/V2I or other D2D communication, such as Proximity Services (ProSe), etc. Communication based on V2V, V2X, V2I, and/or D2D may also be transmitted and received by other transmitting and receiving devices, such as Road Side Unit (RSU), etc.

As shown in FIG. 1, the vehicle 104 may also be called a vehicle user equipment or VUE 104. Similarly, a pedestrian may carry a mobile device with the capabilities described in this disclosure as a pedestrian UE or PUE. Referring again to FIG. 1, in certain aspects, the truck shown as VUE (104) may be configured to include a SnMF function component 198(1), a framework conversion component 198(2), a beam configuration component 198(3), and a measurement report component 198(4). The SnMF function 198(1) component may be configured to provide an indication of sensing directions for transmitting and receiving a radar signal to sense an environment of the apparatus. The SnMF function 198(1) component may also be configured to obtain prior sensing information on target objects in locations of a sensing zone. The SnMF function 198(1) component may be further configured to obtain information on possible RSS time-frequency configurations and beam information that a sensing Tx/Rx node can support along with an optional UE capability report. The framework conversion component 198(2) may be configured to obtain a GCS to LCS conversion framework, and convert the sensing direction in the GCS to the LCS conversion framework. The beam configuration 198(3) component may be configured to determine a beam configuration in LCS based on the obtained prior sensing information. The measurement configuration 198(4) component may be configured to request sensing measurement report for sensing data from network entities of the core network at certain locations. The measurement configuration 198(4) component may also be configured to generate updated sensing measurement report.

The above components 198(1)-(4) and 199 may be performed by one or more processors, or by specialized hardware such as digital signal processors, field programmable gate arrays, integrated circuits using collections of logic gates and other digital circuits, etc. Although the following description may be focused on V2X technologies, the concepts described herein may be applicable to other positioning technologies, including for example proximity-based systems, acoustic location systems, and infrared positioning systems. Further, although the following present disclosure may focus on V2X/D2D in connection with 5G NR, the concepts and various aspects described herein may be applicable to other similar areas, such as LTE, LTE-Advanced (LTE-A), Code Division Multiple Access (CDMA), Global System for Mobile communications (GSM), or other wireless/radio access technologies.

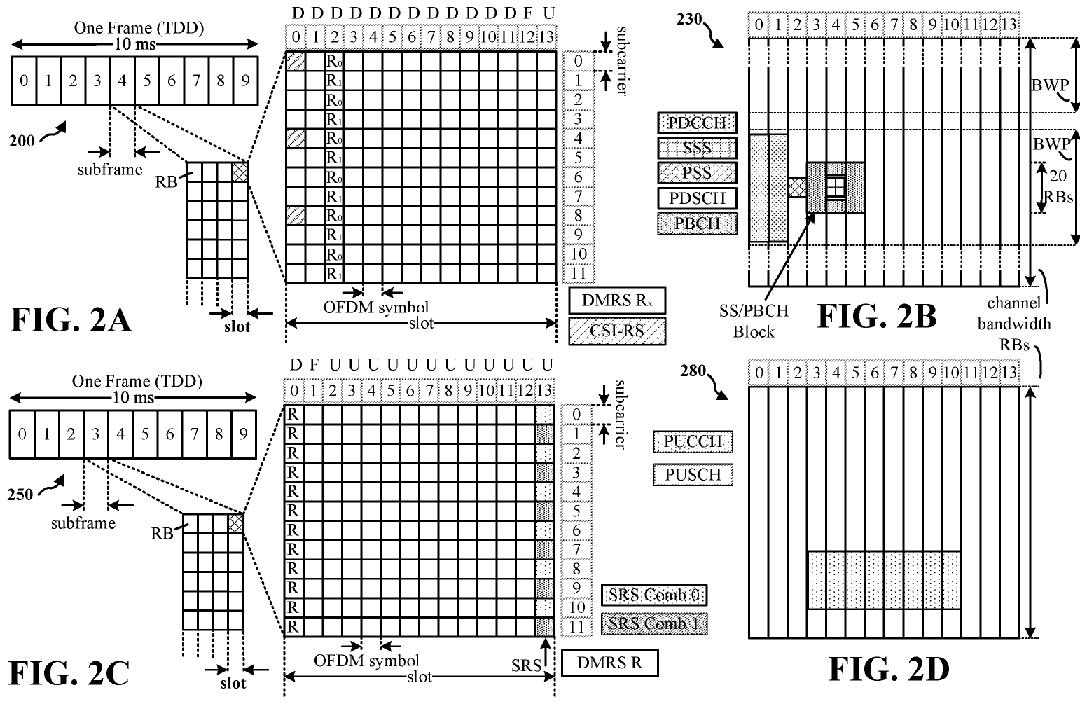

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame, e.g., of 10 milliseconds (ms), may be divided into 10 equally sized subframes (1 ms). Each subframe may include one or more time slots. Subframes may also include mini-slots, which may include, for example, 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) orthogonal frequency-division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}*15 kilohertz (kHz), where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rₓ for one particular configuration, where 100× is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A PDCCH within one BWP may be referred to as a control resource set (CORESET). Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgement (ACK)/non-acknowledgement (NACK) feedback. The PUSCH carries data, and may additionally be used to carry a buffer status report (BSR), a power headroom report (PHR), and/or UCI.

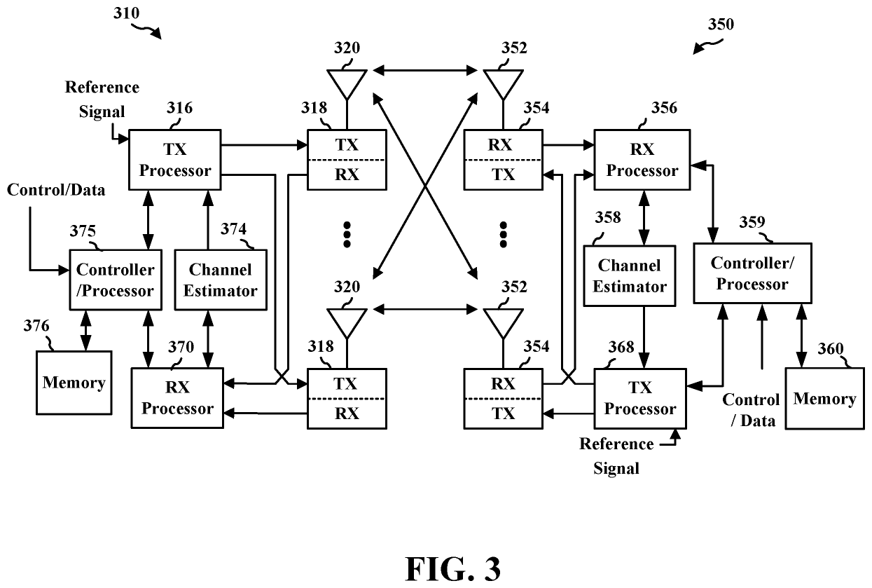

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, onto mapping physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate an RF carrier with a respective spatial stream for transmission.

At the UE 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with components 198(1)-(3) and 199 of FIG. 1. In addition, in certain configurations the UE may be a VUE that includes a SnMF function component 198(1), a framework conversion component 198(2), beam configuration component 198(3), and a measurement report component 198(4). These components, which are described in part in FIG. 1 and are discussed in detail below, may be implemented in FIG. 3 by the elements identified above, or in whole or in part by one or more dedicated or specialized processors, digital signal processors, or dedicated logic circuits.

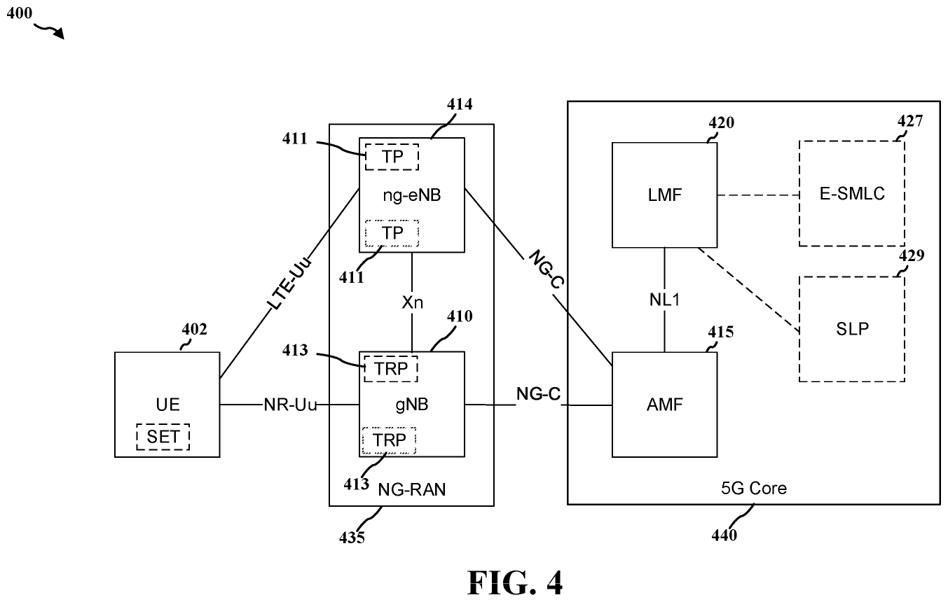

FIG. 4 is a diagram illustrating an example of an UE positioning overall diagram of the communication system, in accordance with various aspects of the present disclosure. Specifically, FIG. 4 shows a positioning architecture diagram applicable to communication system 100 in FIG. 1. As illustrated, the LMF 420 may be in communication with an Enhanced Serving Mobile Location Center (e-SMLFC) 427 (e.g., which may be part of a separate EPC) and a Secure User Plane Location (SUPL) Location Platform (SLP) 429.

LMF 420 is central in the 5G positioning architecture. The LMF 420 receives measurements and assistance information from NG-RAN 434 and the UE 402 via the access and mobility management (AMF) 415 over the interface to compute a position of the UE 402. Due to the new next generation interface between the NG-RAN 435 and the core network 440, a new NR positioning protocol A (NRPPa) protocol was introduced to carry the positioning information between NG-RAN 435 and LMF 420 over the next generation control plane interface (NG-C). These work to provide the framework for positioning in 5G. The LMF 420 configures the UE 402 using the LTE positioning protocol (LPP) via AMF 415. The NG RAN 435 configures the UE 402 using radio resource control (RRC) protocol over LTE-Uu and NR-Uu. It should be noted that gNBs 410 and ng-eNB 414 may not always both be present in the NG-RAN 435. Moreover, when the gNB 410 and the ng-cNB 114 are present, the NG-C interface with the AMF 415 may only be present for one of them.

As illustrated, a gNB 410 may be allowed to control one or more Transmission Points (TPs) 411, such as remote radio heads, or broadcast-only TPs for improved support of DL position methods such as OTDOA, AOD, RTT or ECID. Additionally, a gNB 410 may be allowed to control one or more Transmission Reception Points (TRPs) 413, which performs the function of a transmission point and a reception point.

A TP 411 and/or a TRP 413 may be part of or comprise a Distributed Unit (DU, also referred to as a gNB-DU) in a gNB 102 which manages UL and/or DL transmission and reception for one or more cells according to 5G NR.

The gNB 410 and ng-eNB 414 can communicate with AMF 415 which, for positioning functionality, communicates with a LMF 420. The AMF 415 may support mobility of the UE 104, including cell change and handover and may participate in supporting a signaling connection to the UE 104 and possibly data and voice bearers for the UE 104. The LMF 420 may support positioning of the UE 104 when UE access NG-RAN 435 and may support position procedures/methods such as Assisted GNSS (A-GNSS), Observed Time Difference of Arrival (OTDOA), Real Time Kinematic (RTK), Precise Point Positioning (PPP), Differential GNSS (DGNSS), Enhanced Cell ID (ECID), angle of arrival (AOA), angle of departure (AOD), and/or other positioning procedures. The LMF 420 may also process location services requests for the UE 104, e.g., received from the AMF 415. The LMF 420 may be connected to the AMF 415. The LMF 420 may be referred to by other names such as Location Manager (LM), Location Function (LF), commercial LMF (CLMF) or value added LMF (VLMF).

In some embodiments, a node/system that implements the LMF 420 may additionally or alternatively implement other types of location-support modules, such as an Enhanced Serving Mobile Location Center (E-SMLC) 427, a Secure Location Platform (SLP) 429, or SnMF. It is noted that in some embodiments, at least part of the positioning functionality (including derivations of a UE 104's location) may be performed at the UE 104 (e.g., using signal measurements obtained by UE 104 for signals transmitted by wireless nodes such as gNBs 410 and ng-eNB 114, and assistance data provided to the UE 104, e.g., by LMF 420). The AMF 415 may serve as a control node that processes signaling between the UE 104 and the 5G Core 440, and may provide Quality of Service (QOS) flow and session management. The AMF 415 may support mobility of the UE 104 including cell change and handover and may participate in supporting signaling connection to the UE 104.

A server (not pictured), e.g., a cloud server, may be configured to obtain and provide location estimates of the UE 104 to an external client. For example, the server may pull the location estimate from (e.g., by sending a location request to) the UE 104, one or more of the gNBs 410 (e.g., via the RU, the DU, and the CU) and/or the ng-cNB 414, and/or the LMF 420. As another example, the UE 104, one or more of the gNB1 410 (e.g., via the RU, the DU, and the CU), and/or the LMF 420 may push the location estimate of the UE 104 to the server.

A TRP 413 may be configured to transmit downlink Positioning Reference Signal (DL-PRS or often referred to simply as PRS) according to a selected configuration. The TRP 413 is also configured to perform uplink PRS (UL PRS, which may also be called Sounding Reference Signal (SRS) for positioning) signal measurements such as RTOA, gNB Rx-Tx, or AOA. The PRS is a positioning reference signal that may be referred to as a PRS or PRS signal. The PRS signals are typically sent using the same power and PRS signals with the same signal characteristics (e.g., same frequency shift) may interfere with each other such that a PRS signal from a more distant TRP may be overwhelmed by a PRS signal from a closer TRP such that the signal from the more distant TRP may not be detected. PRS muting may be used to help reduce interference by muting some PRS signals (reducing the power of the PRS signal, e.g., to zero and thus not transmitting the PRS signal). In this way, a weaker (at the UE) PRS signal may be more easily detected by the UE without a stronger PRS signal interfering with the weaker PRS signal. The term RS, and variations thereof (e.g., PRS, SRS, Channel State Information-Reference Signal (CSI-RS)), may refer to one reference signal or more than one reference signal. The TRP 413 is further configured to report UL signal measurements (for a particular UE) to the LMF 420.

The LMF 420 is configured to manage the overall coordination and scheduling of resources required for the location of a UE that is registered with or accessing 5GCN. The LMF 420 may also be configured to calculate or verify a final location and any velocity estimate and may estimate the achieved accuracy. The LMF 420 is further configured to receive location requests for a target UE from the serving AMF 415 using the Nlmf interface. The LMF 420 interacts with the UE 104 in order to exchange location information application to UE assisted and UE based position methods and interacts with the NG-RAN, N3IWF, or TNAN in order to obtain location information. LPP is terminated between a target device (the UE in the control-plane case or SET in the user-plane case) and a positioning server (the LMF in the control-plane case or SLP 429 in the user-plane case).

With a UE-assisted position method, the UE 402 may obtain location measurements and send the measurements to a location server (e.g., the LMF 420) for computation of a location estimate for the UE 104. For example, the location measurements may include one or more of a Received Signal Strength Indication (RSSI), Round Trip signal propagation Time (RTT), Reference Signal Time Difference (RSTD), Reference Signal Received Power (RSRP), and/or Reference Signal Received Quality (RSRQ) for the gNBs 410, the ng-eNBs 414, and/or a WLAN AP.

With a UE-based position method, the UE 402 may obtain location measurements (e.g., which may be the same as or similar to location measurements for a UE-assisted position method) and may compute a location of the UE 402 (e.g., with the help of assistance data received from a location server such as the LMF 420 or broadcast by the gNBs 410, the ng-eNBs 414, or other base stations or APs).

With a network-based position method, one or more base stations (e.g., the gNBs 410, and/or the ng-eNB 414) or APs may obtain location measurements (e.g., measurements of RSSI, RTT, RSRP, RSRQ, or Time of Arrival (ToA) for signals transmitted by the UE 104) and/or may receive measurements obtained by the UE 104. The one or more base stations of APs may send the measurements to a location server (e.g., the LMF 420) for computation of location estimate for the UE 104.

For sensing service, there is a need for beam management across different sensing devices (e.g., UEs 104, gNBs 410, or non-3GPP radar sensors). In addition, beam management may reduce interference, reduce latency for tracking targets, and enable less resource/power usage for sensing. For example, reducing latency for tracking targets by skipping exhaustive scanning or complex full processing can be achieved by exploiting prior sensing measurement reports collected by a SnMF. In addition, reducing sensing congestion and increased communication performance (e.g., when JCR is implemented using resource/power sharing between sensing and communication) may help enable less resources and power usage for sensing. However, unlike RAN, a core network does not understand beam configuration. Thus, the core network cannot manage the beam in a way needed to support sensing service.

### RF Sensing (Passive Localization)

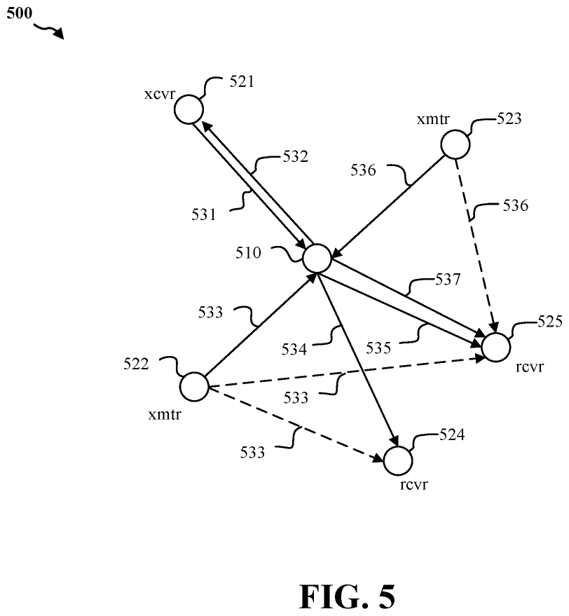

FIG. 5 is a diagram illustrating a passive localization configuration, in accordance with various aspects of the present disclosure. Referring to FIG. 5, a passive localization configuration 500 includes a target object 510, a transceiver 521, transmitters 522, 523, and receivers 524, 525. Whereas positioning techniques such as RTT, OTDOA, UTDOA (UL OTDOA), and E-CID are active localization techniques, with a target device including an RF device, passive localization techniques may be used to determine position information for a target device that may or may not contain an RF device. Passive localization is known as RF sensing and has numerous applications including health detection, contextual information acquisition, automotive radar, etc. Health detection applications detect one or more biological functions (e.g., measuring one or more biological metrics) and include, for example, heartbeat detection, heart rate detection, respiration detection, and respiration rate detection. The biological function(s) may be monitored, being detected over time. Contextual information acquisition applications include, for example, location detection, location tracking, direction finding, and range estimation. Automotive radar applications include, for example, smart cruise control (to maintain a separation (e.g., driver-specified distance, a safe distance (e.g., driver-specified or preprogrammed time separation)) between a first vehicle and second vehicle ahead of the first vehicle and in the same lane), collision avoidance, etc.

The configuration 500 is an example of multistatic radar. A co-located transmitter and receiver (transceiver) is called a monostatic radar and a transmitter not co-located with the receiver is called a bistatic radar. A multistatic radar contains multiple spatially diverse monostatic and/or bistatic radars with a shared coverage area. In this example, the transceiver 521 provides a monostatic radar, with a transmitted signal 531 being reflected as a reflected signal 532 that is received by the transceiver 521. The transmitter of the transceiver 521, the transmitters 522, 523, and the receivers 524, 525 provide bistatic radars, with a transmitted signal 533 from the transmitter 522 being reflected as reflected signals 534, 535 that are received by the receivers 524, 525, respectively, and a transmitted signal 536 from the transmitter 523 being reflected as a reflected signal 537 that is received by the receiver 525. Other signals may be transmitted, and other reflections received (e.g., by the receiver of the transceiver 521), but are not shown in FIG. 5 for the sake of simplicity of the figure. For example, the transmitted signal 536 may be reflected and received by the receiver 524, and/or the signal 531 may be reflected and received by one or both of the receivers 524, 525, but these reflections are not shown for sake of simplicity of the figure. In addition to receiving the reflected signals 534, 535, 537, one or more of the receivers 524, 525 may receive the transmitted signals 533, 536 directly from the transmitters 522, 523, with the transmitted signals 533, 536 and the reflected signals 534, 535, 537 being used to determine RF sensing information (e.g., range to an object, object presence, channel characteristics, etc.). The transmitted signal 531 may also be received by one or more of the receivers 524, 525 directly and reflections of the transmitted signal 531 received by one or more of the receivers 524, 525, but these signal paths are not shown in FIG. 5 for the sake of simplicity of the figure.

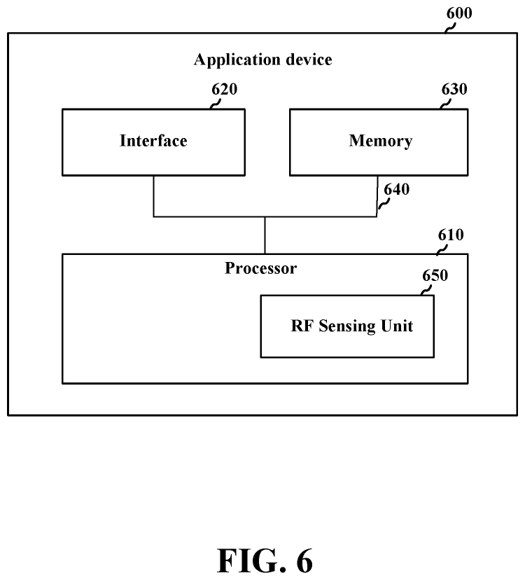

FIG. 6 is a diagram illustrating an example application device, in accordance with various aspects of the present disclosure. Referring to FIG. 6, with further reference to FIGS. 1-5, an application device 600 includes a processor 610, an interface 620, and a memory 630 communicatively coupled to each other by a bus 640. The application device 600 may include the components shown in FIG. 6, and may include one or more other components. For example, the application device 600 may be a UE, may be part of the UE or VUE (e.g., the UE 104 shown in FIG. 1 and the UE 402 shown in FIG. 4) part of the TRP (e.g., the TRP 413 shown in FIG. 4), or part of the server, and thus may include one or more components shown in FIG. 1, FIG. 2, FIG. 3, or FIG. 4. For example, the processor 610 may include one or more of the components of the processor. The interface 620 may include one or more of the components of the transceiver, or the transceiver, or the transceiver. For example, the interface 620 may include the wireless transmitter 354TX and the antenna 320, 352 or the wireless receiver 354RX and the antenna 320, 352 or the wireless transmitter 354TX, the wireless receiver 354RX, and the antenna 320, 352. Also or alternatively, the interface 620 may include the wired transmitter and/or the wired receiver. The memory 630 may be configured similarly to the memory 360, 376, e.g., including software with processor-readable instructions configured to cause the processor 610 to perform functions.

The description herein may refer to the processor 610 performing a function, but this includes other implementations such as where the processor 610 executes software (stored in the memory 630) and/or firmware. The description herein may refer to the application device 600 performing a function as shorthand for one or more appropriate components (e.g., the processor 610 and the memory 630) of the application device 600 performing the function. The processor 610 (possibly in conjunction with the memory 630 and, as appropriate, the interface 620) includes an RF sensing unit 650 configured to request RF sensing for determining position information (e.g., one or more RF measurements, one or more ranges, one or more position estimates, etc.) for a target object, and for receiving RF sensing reports regarding an RF sensing outcome. The RF sensing unit 650 is discussed further below, and the description may refer to the processor 610 generally, or the application device 600 generally, as performing any of the functions of the RF sensing unit 650, and the application device 600 is configured to perform the functions of the RF sensing unit 650. The application device 600 is an application layer entity that may be connected to an SnMF directly or indirectly (e.g., through the AMF 415) to request the RF sensing and to receive the RF sensing report.

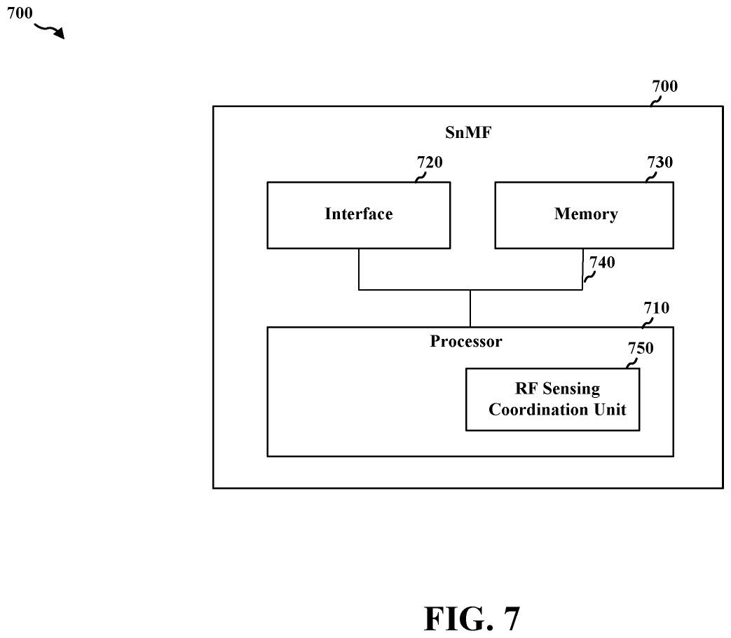

FIG. 7 is a diagram illustrating an example sensing management function, in accordance with various aspects of the present disclosure. Referring also to FIG. 7, an SnMF 700 includes a processor 710, an interface 720, and a memory 730 communicatively coupled to each other by a bus 740. The SnMF 700 may include the components shown in FIG. 7, and may include one or more other components. For example, the SnMF 700 may be part of the server, and thus may include one or more components shown in FIG. 4, or may be a standalone device. For example, the interface 720 may include one or more of the components of the transceiver (e.g., the wireless transmitter and the antenna and/or the wireless receiver and the antenna and/or the wired transmitter and/or the wired receiver). The memory 730 may be configured similarly to the memory 360 and/or the memory 376, e.g., including software with processor-readable instructions configured to cause the processor 710 to perform functions. The SnMF 700 and the server and/or the TRP 413 may be integrated in a physical entity, with the SnMF 700 and the server and/or the TRP 413 sharing one or more components.

The description herein may refer to the processor 710 performing a function, but this includes other implementations such as where the processor 710 executes software (stored in the memory 730) and/or firmware. The description herein may refer to the SnMF 700 performing a function as shorthand for one or more appropriate components (e.g., the processor 710 and the memory 730) of the SnMF 700 performing the function. The processor 710 (possibly in conjunction with the memory 730 and, as appropriate, the interface 720) includes an RF sensing coordination unit 750. The RF sensing coordination unit 750 is configured to respond to an RF sensing request from the application device 600 by scheduling RF sensing, collecting information from the RF sensing, and providing RF sensing reports with outcomes of the RF sensing (e.g., including position information for one or more target objects and/or one or more target environments). The RF sensing coordination unit 750 is discussed further herein, and the description may refer to the processor 710 generally, or the SnMF 700 generally, as performing any of the functions of the RF sensing coordination unit 750, and the SnMF 700 is configured to perform the functions of the RF sensing coordination unit 750.

RF sensing may be requested by the RF sensing unit 650 and coordinated by the RF sensing coordination unit 750 for a variety of purposes. For example, the RF sensing unit 650 may request object presence detection to detect the presence of one or more target objects in a specified region. For object presence detection (or simply, presence detection), the RF sensing coordination unit 750 may select one or more relevant nodes for the region, e.g., one or more base stations (e.g., gNBs) and/or one or more UEs in or near the region, e.g., a room, an outdoor area, etc., and determine whether a channel is time varying (indicating introduction, removal, and/or movement of one or more objects). As another example, the RF sensing unit 650 may request health (e.g., biological function) detection for one or more entities (e.g., heart rate detection for a human being or other living thing). For biological function detection, the RF sensing coordination unit 750 may coordinate a pair of entities (e.g., one or more base stations and/or one or more UEs) to obtain Doppler measurements of signals reflected from a target object. The Doppler measurements may be analyzed to determine biological function, e.g., heart rate, respiration, respiration rate, etc. As another example, the RF sensing unit 650 may request environment mapping to measure one or more characteristics of an environment. For environment mapping, the RF sensing coordination unit 750 may coordinate measurement (e.g., schedule signaling and request measurement) of one or more characteristics (e.g., path loss, fading, interference, Doppler shift, etc.) of one or more RF channels by one or more entities (e.g., one or more base stations and/or one or more UEs). The SnMF 700 may be configured to provide SLAM (Simultaneous Localization And Mapping) to determine an environment map and determine a position of a target object within the map.

As will be described below, the SnMF in the core network may also be used to indicate sensing direction to different sensors directly via NG-RAN. In contrast to the LMF (e.g., LMF 420 shown in FIG. 4) configured for positioning functions in the core network, the SnMF is configured to sense direction indication. In some examples, the SnMF may replace the LMF or be an extension of LMF.

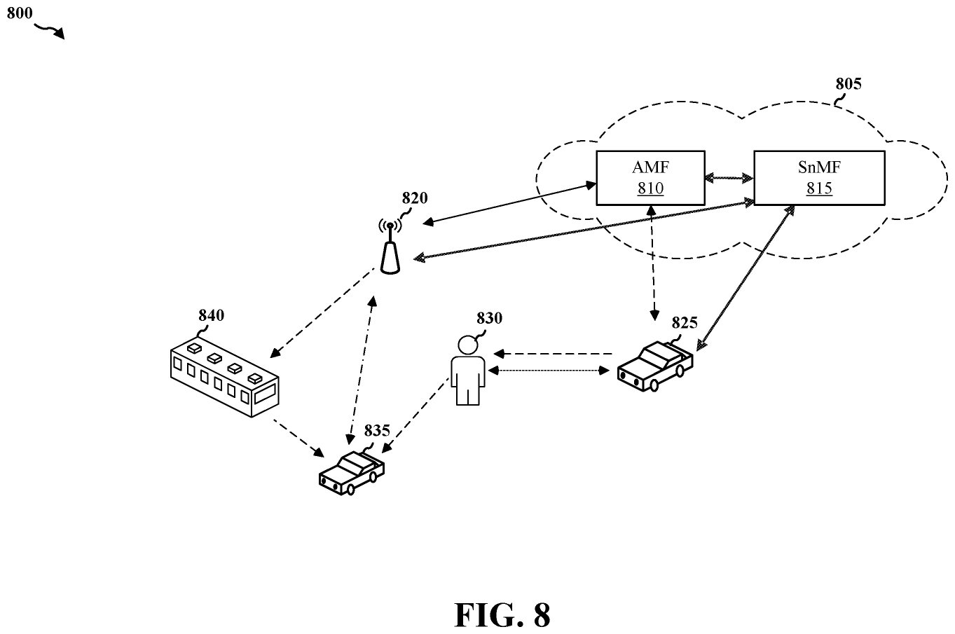

FIG. 8 is a diagram illustrating an example of a wireless communications system that supports architecture options for cooperative sensing and positioning, in accordance with various aspects of the present disclosure. In some examples, wireless communication system 800 may implement aspects of access network 100. Wireless communications systems 800 may include, but is not limited to, a core network 805 comprising AMF 810 and SnMF 815, base station 820, UE-A 825, a Target Object 1 830, UE-B 835, and Target Object 2 840, which may be examples of corresponding devices described herein. In some aspects, base station 820, UE-A 825, and UE-B 835 may constitute at least a portion of a RAN, such as LTE RAN, LTE-A RAN, NR RAN, NG RAN, 5G access network (5G-AN), etc. In some aspects, base station 820, UE-A 825, and UE-B 835 may also be referred to generically as wireless nodes of the RAN.

FIG. 8 illustrates several different use case scenarios in which multiple target objects 840, 826 can be tracked by a combination of UE-A 825, UE-B 835, or NG-RAN 820 using SnMF 815. In general, there are different types of radar, and in particular, monostatic and bistatic radars. Unlike monostatic sensing, which can autonomously be performed by a single node, bistatic sensing requires some coordination between two (or more) counterparts. As a first example of mono-static sensing. UE-A can be performing monostatic sensing (as indicated by a dotted line).

As a second example of mono-static sensing, UE-B can be performing monostatic sensing (as indicated by a dotted line). As a first example of bi-static sensing, consider target object 1 830 and target object 2 840, UE-B 835 is receiving the bi-static sensing (as indicated by a dashed line) that is transmitted from UE-A 825. As a second example of bi-static sensing, NG-RAN 820 may be performing bi-static sensing and UE-B 835 may be receiving the bi-static sensing. Accordingly, there is a need to indicate different directions for sensing target objects (e.g., target object 1 830 and/or target object 2 840) by UE-A 825, UE-B 835 or NG-RAN 820 to sense in that direction.

Accordingly, aspects of the described techniques introduce various examples of an architecture that may be implemented in wireless communications systems 800 that supports or otherwise enables RF sensing. For example, AMF 810 and SnMF 815 may generally be deployed within core network 805 of the wireless communication system 800 to monitor, control, or otherwise manage various aspects of RF sensing. In some examples, this may include SnMF 815 processing the RF signal metrics associated with one or more objects that are received from various wireless nodes of the RAN (e.g., such as base station 820 as well as any of the UEs). SnMF 815 may identify or otherwise determine the properties of the object based on the RF signal metrics. SnMF 815 may transmit or otherwise provide an indication of the properties of the object based on the RF signal metrics. SnMF 815 may transmit or otherwise provide an indication of the objects which uses this information to identify or otherwise determine mapping information for the object(s), e.g., which may be part of a larger mapping operation within wireless communication system 200.

In some aspects, or SnMF 815 may be implemented in hardware and/or software within core network 805. SnMF 815 may be implemented as an independent/separate component/function within core network 805 and/or may be combined with one or more other component(s)/function(s) within core network 805, such as LMF. SnMF 815 may operate as a service-based component within the core network 805 and the interaction between SnMF 815 and other core network functions may be a service-based representation and/or a reference point representation. For example, the service based representation may include the network functions (e.g., SnMF 815, AMF 810) within the control plane enabling other authorized network functions to access their services (which may include point-to-point reference points where necessary). The reference point representation may include the interaction existing between the network function services in the network functions described as point-to-point reference points between any two network functions (e.g., between AMF 810 and SnMF 815). Accordingly, SnMF 815 may communicate via one or more interfaces within core network 805, e.g., a service based interface, such as Naf interface, Nsnmf interface, an Namf interface, and/or a reference point interface, and the like. In some aspects, an existing interface may be utilized for communications/coordination between SnMF 815 and other core network functions and/or a new interface (e.g., an Nsnmf interface) may be created for communication/coordination between SnMF 815 and other core network functions of core network 805. Accordingly, references to SnMF 815 and/or other network functions providing, obtaining, etc. may generally refer to information transmitted or otherwise conveyed via any interface between the various network entities.

As shown in FIG. 8, the SnMF 815 may be configured to indicate a sensing direction or a set of sensing directions in a GCS to NG-RAN 820 or UE 825, 835 for sensing signal transmission and/or reception. If the sensing directions are indicated in GCS, then UE-A 825, UE-B 835, or gNB 820 may convert the sensing directions into LCS. In some examples, the sensing directions may be indicated in LCS if the SnMF 815 has been provided with a GCS-LCS conversion framework.

In some examples, the sensing direction may be indicated using a direction cookbook with certain quantization levels. In some examples, sensing direction is indicated using a direction codebook with certain quantization levels. In some examples, the quantization level is chosen by SnMF 815. In some examples, the quantization level may be requested by gNB 820 for network based sensing or UE-based/assisted sensing in mode-1. In some examples, the quantization level can be requested directly by UE for UE-based/assisted sensing in mode-2. For example, if there are four levels of quantization, then the codebook may indicate 0 for 0 degrees to 90 degrees, indicate 1 for 90 degrees to 180 degrees, indicate 2 for 180 degrees to 270 degrees, and indicate 3 for 270 degrees to 360 degrees. As another example, the codebook can be used when quantization is even finer and can be based on 30 degrees. Accordingly, in this example, the codebook may indicate 0 for 0 degrees to 30 degrees, 1 for 30 degrees to 60 degrees, 2 for 60 degrees to 90 degrees, 3 for 90 degrees to 120 degrees, 4 for 120 degrees to 150 degrees, 5 for 150 degrees to 180 degrees, 6 for 180 degrees to 210 degrees, 7 for 210 degrees to 240 degrees, 8 for 240 degrees to 270 degrees, 9 for 270 degrees to 300 degrees, 10 for 300 degrees to 330 degrees, and 11 for 330 degrees to 360 degrees.

In some examples, the quantization level may be coarser than the beamwidth supported by gNB 820 or UE 825, 835. In this case, gNB 820 or UE 825, 835 may choose their beam in LCS from a set of beam directions after converting the sensing direction indicated by SnMF 815 in GCS to LCS.

In some examples, the direction codebook is informed to SnMF 815 by gNB 820 or UE 825, 835. In this case, UE 825, 835 or gNB 820 converts the set of beam directions of interest from LCS to GCS before sending the direction codebook informed to SnMF 815.

In some examples, the choice of beam direction from a set of possible directions in LCS (after being converted from GCS) by gNB 820 or a UE 825, 835 can be based on additional scanning, chosen randomly, or using some additional rules. The additional rule may be indicated by SnMF 815 to gNB 820, by gNB 820 to UE 825, 835, or by a UE to another UE.

Accordingly, NG-RAN 820 may be configured to obtain the Tx/Rx beam configuration in local LCS based on the sensing direction indication in GCS indicated by the SnMF 815. This procedure may be implemented for network-based sensing when NG-RAN 820 is participating in sensing such as gNB as Tx in bistatic mode with a UE or another gNB as a RX, gNB as Rx in bistatic sensing mode with a UE or another gNB as a Tx, or a gNB as Tx/Rx in monostatic sensing. In some examples, this procedure may also be used for UE-based or UE-assisted sensing in mode-1 (with Uu connection, as indicated in a dotted-dashed line) when a UE already provided GCS to LCS conversion framework to NG-RAN 820.

In some examples UE-A 825 and/or UE-B 835 will obtain Tx/Rx beam configuration locally based on SnMF sensing indication in GCS. This procedure may be implemented for UE-based or UE-assisted sensing to indicate sounding reference signal (SRS) indices when UE is the Tx mode for bistatic or monostatic sensing in mode-1 (with Uu connection) or mode-2 (without gNB connection) sensing. This procedure may also be used for UE-based or UE-assisted sensing to determine which Rx beam to use in bistatic mode in mode-1 or mode-2 sensing.

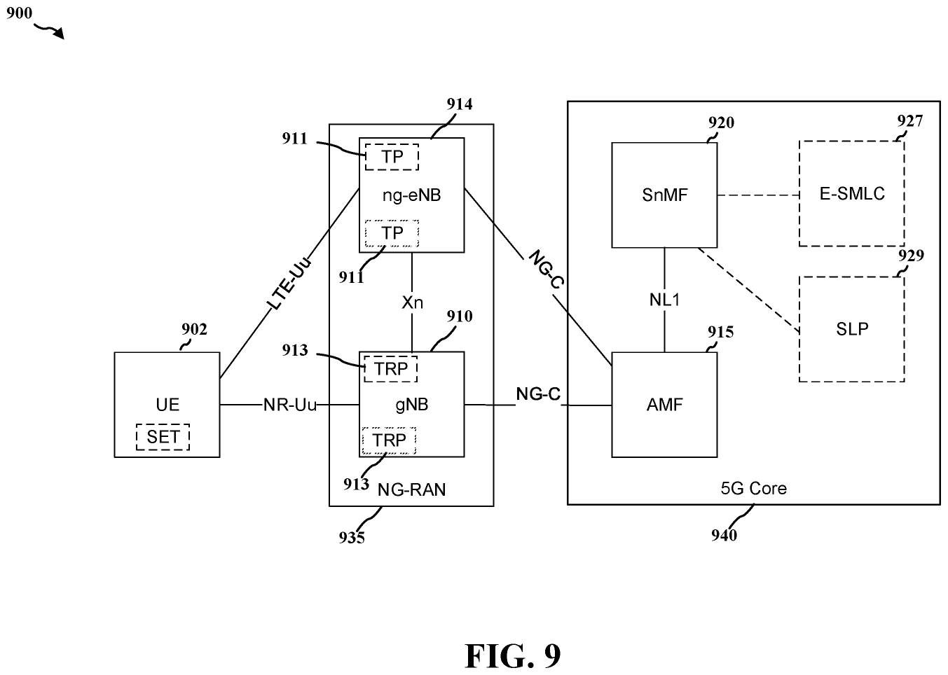

FIG. 9 is a diagram illustrating an example of an UE positioning overall diagram of the communication system, in accordance with various aspects of the present disclosure. Specifically, the example 900 in FIG. 9 shows a similar positioning architecture diagram as in FIG. 4, except that the SnMF 920 replaces a LMF. Generally, LMF is configured to control the coordination and schedule of resources for positioning purposes. In some cases, an LMF may be extended to include the management functions contained in SnMF 920. Unlike the LMF, SnMF is configured to perform sensing and positioning. SnMF 920 is configured to control sensing indication. Specifically, SnMF 920 may be configured to receive prior sensing information on target objects in certain locations for a given sensing zone.

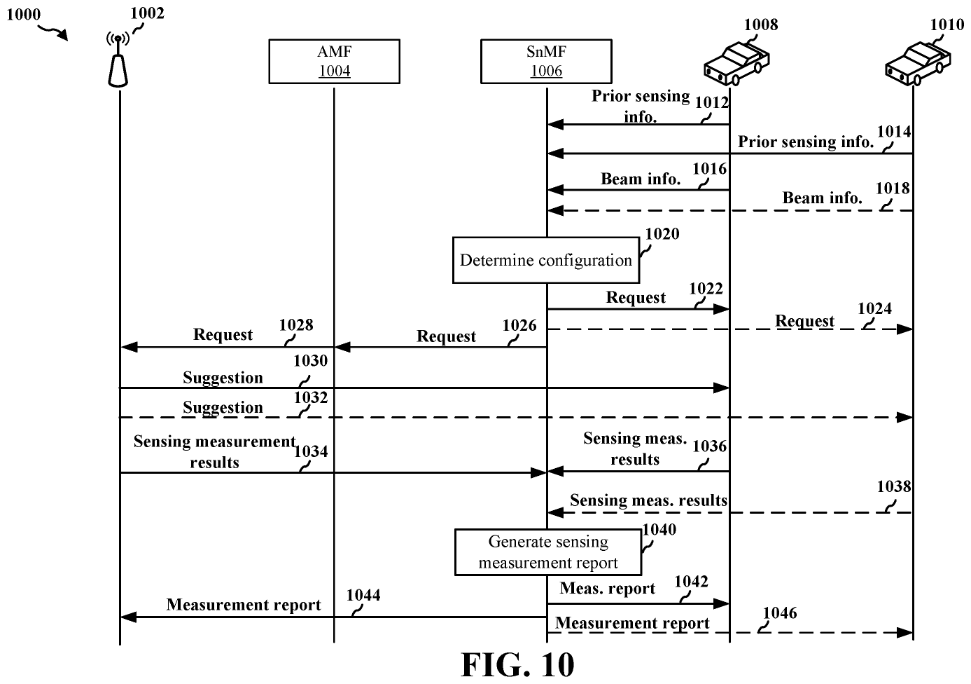

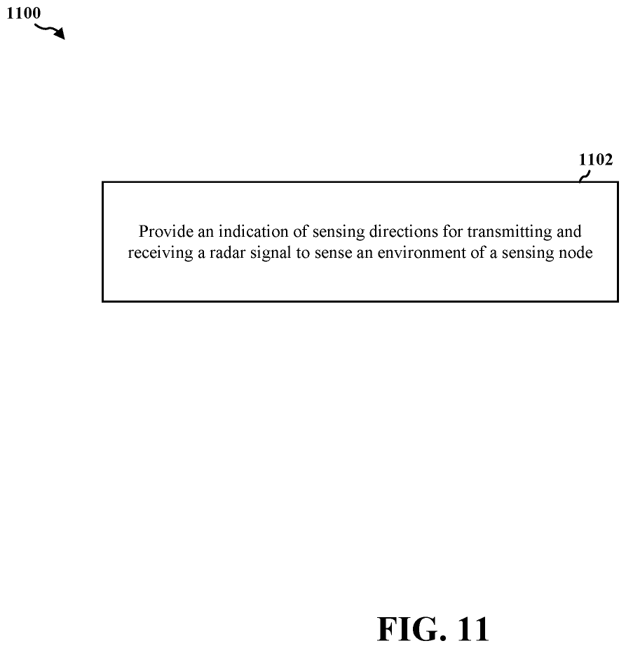

FIG. 10 illustrates an example 1000 of a call flow between a gNB 1002 (e.g., base station 102/180, 820), an AMF 1004 (e.g., AMF 415, 810), a SnMF 1006 (e.g., SnMF 700, 815), a first UE (e.g., UE-A 825) 1008, and, optionally, a second UE (e.g., UE-B 835) 1010. Optional aspects are illustrated in dashed lines. At block 1012, the SnMF 1006 is configured to receive prior sensing information on target objects (e.g., target object 1 830 and target object 2 840 shown in FIG. 8) in certain locations for a given sensing zone from the first UE 1008. Optionally, at block 1014 the SnMF 1006 is configured to receive prior sensing information on target objects in certain locations for a given sensing zone. In some examples, sensing nodes (e.g., sensing UE or processing sensing server node) may automatically send the measurement report or data to generate sensing measurements. In some examples, the SnMF 1006 may request sensing measurement reports to determine configuration or change in configuration. In some examples, the SnMF 1006 may request for sensing measurement report or sensing data from UEs at certain locations such that the request may be sent to selected sensing nodes or UE/gNBs connected to sensing nodes after determining which sensing node to use and/or with what configurations to collect the measurement reports, this will be described in more detail below.

At block 1016, the SnMF 1006 is configured to receive information on possible RRS time-frequency configurations and beam information that a sensing Tx/Rx node(s) can support along with an optional capability report from the first UE 1008. Optionally, at block 1018, the SnMF 1006 is configured to receive information on possible RRS time-frequency configurations and beam information that a sensing Tx/Rx node(s) can support along with an optional capability report from the second UE 1010.

At block 1020, the SnMF 1006 is configured to determine configurations or a change in configuration of a UE/gNB/non-3GPP sensor with a set of RRS time-frequency configurations along with which Tx/RX sensing directions to use based on blocks 1012, 1016.

At block 1022, the SnMF 1006 is configured to request a sensing measurement report via LPP to the first UE 1008, or via NRPP (a) or using AMF 1004, at block 1026, to gNB 1002 at block 1028. Optionally, at block 1024, the SnMF 1006 is configured to request a sensing measurement report via LPP to the second UE 1010. In some examples, the request for the sensing measurement report is sent to selected sensing nodes or UE connected to these sensing nodes after determining which sensing noted to use and/or with what configurations (e.g., which frequency bands, the duration, etc.) to collect.

At block 1030, the gNB 1002 is configured to suggest to the first UE 1030. Optionally, at block 1032, the gNB 1002 is configured to suggest to the second UE 1036.

At block 1034, the gNB 1002 is configured to send a sensing measurement result (e.g., measurement report of partial processed results) for different beam combinations to SnMF 1004 such that the results can be indexed with corresponding sensing directions used. At block 1036, the first UE 1008 is configured to send a sensing measurement result (e.g., measurement report of partial processed results) for different beam combinations to SnMF 1004 such that the results can be indexed with corresponding sensing directions used. Optionally, at block 1038, the second UE 1010 is configured to send a sensing measurement result (e.g., measurement report of partial processed results) for different beam combinations to SnMF 1004 such that the results can be indexed with corresponding sensing directions used. In some examples, the SnMF 1006 may send a request for sensing measurement report or sensing data from UEs at certain locations.

At block 1040, the SnMF 1006 is configured to generate better sensing measurement reports for a given UE using the received measurement results.

At block 1042, SnMF 1006 is configured to send the results of the better sensing measurement report to the first UE 1008. At block 1044, SnMF 1006 is configured to send the results of the better sensing measurement report to the second UE 1008. At block 1046, SnMF 1006 is configured to send the results of the better sensing measurement report to the gNB 1002. Here, the better sensing measurement report can be used to enforce steps 1012, 1014.

FIG. 11 is a flowchart of a method 1100 of wireless communication at a first network entity of a core network. The method may be performed by a first UE or VUE (e.g., the UE-A 825). The method allows a first UE to indicate a sensing direction or a set of sensing directions to NG-RAN 820 or UEs for sensing signal transmission and/or reception.

At 1100, the method 1100 includes providing, to one or more wireless nodes of a NG-RAN associated with the core network or a second network entity (e.g., UE-B 835) of the core network different from the first entity (e.g., UE-A 825), an indication of sensing directions for transmitting and receiving a radar signal to sense an environment of the apparatus. In an example, referring back to FIG. 8, UE-A 825 is configured to provide, to one or more wireless nodes of the NG-RAN 820 associated with the core network 805, an indication of sensing directions for transmitting and receiving a radar signal to sense an environment of the apparatus. In another example, referring back to FIG. 9, a UE 902 is configured to provide, to one or more wireless nodes of the NG-RAN 835 associated with the core network 840, an indication of sensing directions for transmitting and receiving a radar signal to sense an environment of the apparatus.

In some examples, the sensing directions are indicated in a GCS. In some examples, the sensing directions are further indicated using a direction cookbook with a particular quantization level. In some examples, the particular quantization level is determined by the first network entity of the core network. In some examples, the particular quantization level is coarser than a beamwidth supported by the one or more wireless nodes of the NG-RAN or the second entity of the core network provided with the indication of sensing directions.

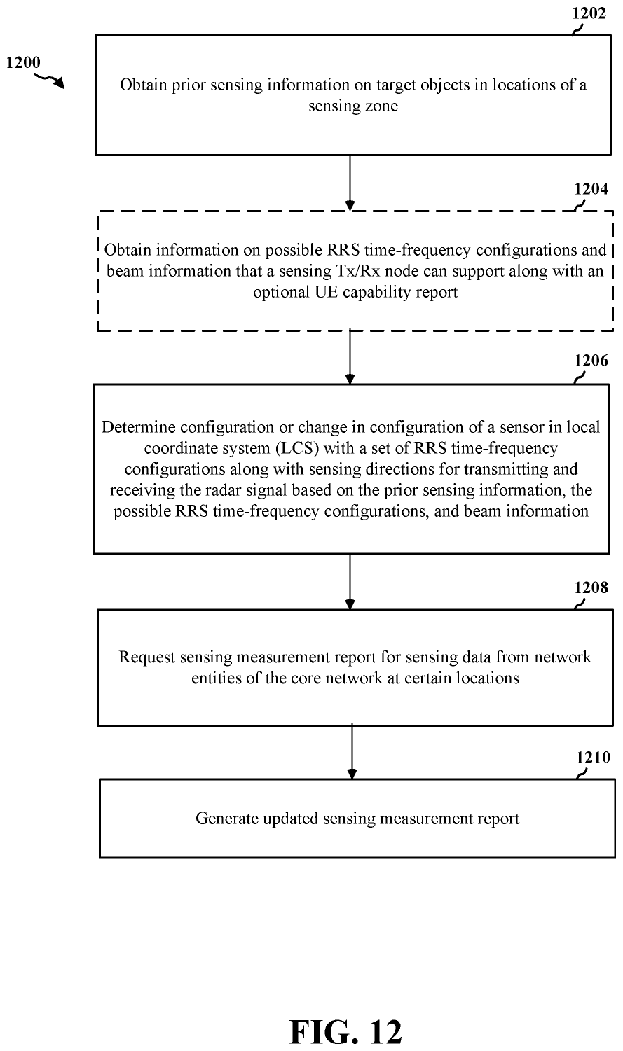

FIG. 12 is a flowchart of a method 1200 of wireless communication at a first network entity of a core network. The method may be performed by a first UE (e.g., the UE-A 825). Optional aspects are illustrated in dashed lines. The method allows a first UE to indicate a sensing direction or a set of sensing directions to NG-RAN 820 or UEs for sensing signal transmission and/or reception.

At 1202, the method 1200 includes obtaining prior sensing information on target objects in locations of a sensing zone. In some examples, the prior sensing information is obtained based on receiving measurement report or data. In an example, referring back to FIG. 8, the SnMF 815 may obtain prior sensing information from a UE-A 825 or UE-B 835 based on receiving measurement report or data. In another example, referring back to FIG. 9, the SnMF 820 may obtain prior sensing information from a UE 902 based on receiving measurement report or data. In yet another example, referring back to FIG. 10, the SnMF 1006 may obtain prior sensing information 1012 from a first UE 1008 or a second UE 1010 based on receiving measurement report or data.

Optionally, at 1204, the method 1200 includes obtaining information on possible RRS time-frequency configurations and beam information that a sensing Tx/Rx node can support along with an optional UE capability report. In an example, referring back to FIG. 8, the SnMF 815 may obtain information on possible RRS time-frequency configurations and beam information that a sensing Tx/Rx node can support along with an optional UE capability report. In another example, referring back to FIG. 9, the SnMF 820 may obtain information on possible RRS time-frequency configurations and beam information that a sensing Tx/Rx node can support along with an optional UE capability report. In yet another example, referring back to FIG. 10, the SnMF 1006 may also obtain information on possible RRS time-frequency configurations and beam information 1016, 1018 that a sensing Tx/Rx node can support along with an optional UE capability report.

At 1206, the method 1200 includes determining configurations or a change in configurations of a sensor in LCS with a set of RRS time-frequency configurations along with sensing directions for transmitting and receiving the radar signal based on the prior sensing information, the possible RRS time-frequency configurations, and beam information. In an example, referring back to FIG. 8, the SnMF 815 may determine configurations or a change in configurations of a sensor in LCS. In another example, referring back to FIG. 10, the SnMF 1006 may determine configurations or a change in configurations of a sensor in LCS 1020 with a set of RRS time-frequency configurations along with sensing directions for transmitting and receiving the radar signal based on the prior sensing information 1012, 1014, the possible RRS time-frequency configurations, and beam information 1016, 1018.

Coarse zone scanning may be utilized to speed up the sensing needs in a zone, to assist an initiating UE (or gNB or sensing client) to meet their sensing needs, or to target track a few objects between different gNBs (e.g., target object 2 840). As a first example of coarse zone scanning, certain gNB can trigger for its sensing zone. Here, the gNB coverage area for sensing may be assigned as SnMF sensing zone. As a second example of coarse scanning, AMF 1004 can assign a SnMF 1006 with its sensing zone based on requests from multiple UEs that need to sense within a certain sensing area that overlaps. In the case of target tracking, target identifiers may be assigned to target objects (e.g., target object-1 830 or target object 2 840 shown in FIG. 8 with or without communication connection) by AMF 1004. In some examples, positioning standards have identifiers only for UEs. In some examples, the identifiers could be based on specific heatmap sensing signature in range-angle-Doppler domain. In some examples, the identifiers could be based on range, directions, and gNB assignment trajectory.

At 1208, the method 1200 includes requesting sensing measurement report for sensing data from network entities of the core network at certain locations. In an example, referring back to FIG. 8, the SnMF 815 may request sensing measurement report for sensing data from network entities 825, 835, 820 of the core network 805 at certain locations. In another example, referring back to FIG. 10, the SnMF 1006 may request sensing measurement report for sensing data from gNB 1002, the first UE 1008, and/or the second UE 1010 of the core network 805 at certain locations.

At 1210, the method 1200 includes generating an updated sensing measurement report for a given UE. In an example, referring back to FIG. 8, the SnMF 815 may generate an updated sensing measurement report. In another example, referring back to FIG. 10, the SnMF 1006 may generate an updated sensing measurement report 1040.

In some examples, optionally, the method 1200 further includes transmitting the result of the updated sensing measurement reports back to the relevant UEs or gNBs.

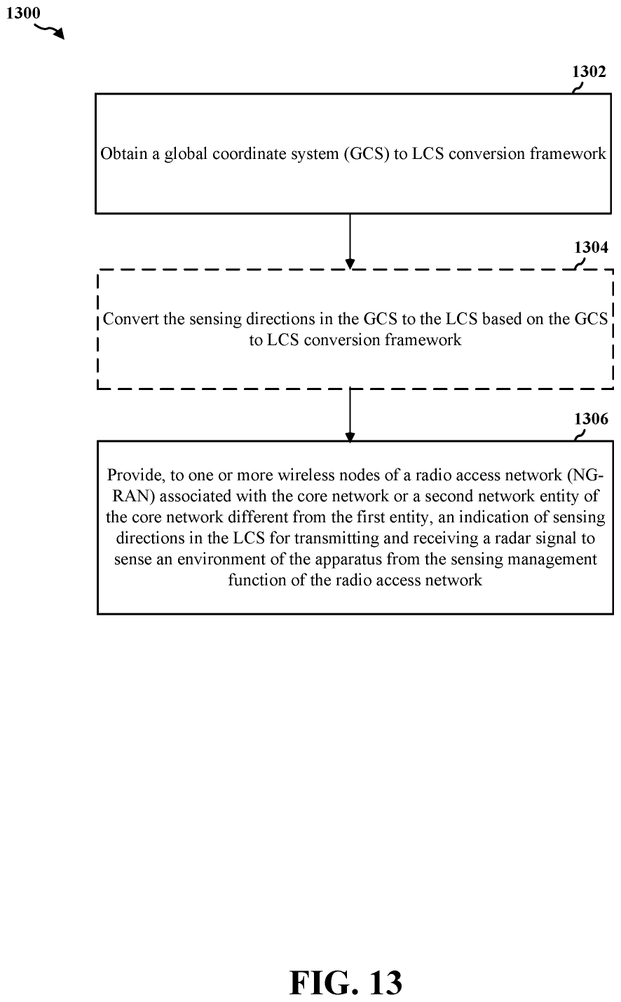

FIG. 13 is a flowchart of a method 1300 of wireless communication at a first network entity of a core network. The method may be performed by a first UE (e.g., the UE-A 825). Optional aspects are illustrated in dashed lines. The method allows a first UE to indicate a sensing direction or a set of sensing directions to NG-RAN 820 or UEs for sensing signal transmission and/or reception.

At 1302, the method 1300 includes obtaining a global coordinate system (GCS) to LCS conversion framework. In an example, referring back to FIG. 8, UE-A 825 and/or UE-B 835 may provide gNB 820 with a GCS to LCS conversion framework.

Optionally, at 1304, the method 1300 includes converting the sensing directions in the GCS to the LCS based on the GCS to LCS conversion framework, wherein the indication of sensing directions is indicated in LCS.

At 1306, the method 1300 includes providing, to one or more wireless nodes of a NG-RAN associated with the core network or a second network entity of the core network different from the first entity, an indication of sensing directions in the LCS for transmitting and receiving a radar signal to sense an environment of the apparatus from the sensing management function of the radio access network.

In some examples, the indication of sensing directions is provided from the SnMF function of the radio access network. In some examples, the sensing management function of the radio access network operates separately from a location management function of the core network to determine one or more properties of an object. In some examples, the sensing management function of the radio access network comprises a combined radio access network component that is combined with a location management component of the radio access network.

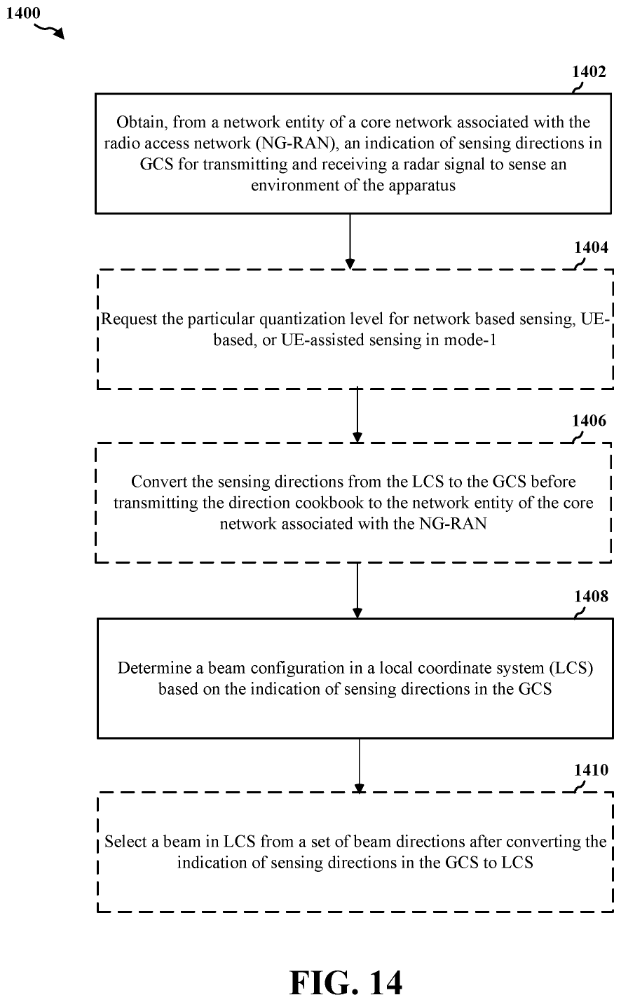

FIG. 14 is a flowchart of a method 1400 of wireless communication at a component of a radio access network. Optional aspects are illustrated in dashed lines. The method may be performed by a NG-RAN 820. The method allows NG-RAN to provide a sensing direction or a set of sensing directions to UEs for sensing signal transmission and/or reception.

At 1402, the method 1400 includes obtaining, from a network entity of a core network associated with the NR-RAN, an indication of sensing directions in GCS for transmitting and receiving a radar signal to sense an environment of the apparatus. In some examples, the sensing directions are indicated using a direction cookbook with a particular quantization level. In some examples, the direction cookbook is informed from the network entity of a core network.

Optionally, at 1404, the method 1400 includes requesting the particular quantization level for network-based sensing, UE-based, or UE-assisted sensing in mode-1. In some examples, the particular quantization level is coarser than a beamwidth supported by the apparatus.

Optionally, at 1406, the method 1400 includes converting the sensing directions from the LCS to the GCS before transmitting the direction cookbook to the network entity of the core network associated with the NG-RAN. In some examples, the sensing directions are converted based on additional scanning. In some examples, the sensing directions are converted randomly.

At 1408, the method 1400 includes determining a beam configuration in the LCS based on the indication of sensing directions in the GCS.

Optionally, at 1410, the method 1400 includes selecting a beam in LCS from a set of beam directions after converting the indication of sensing directions in the GCS to the LCS.

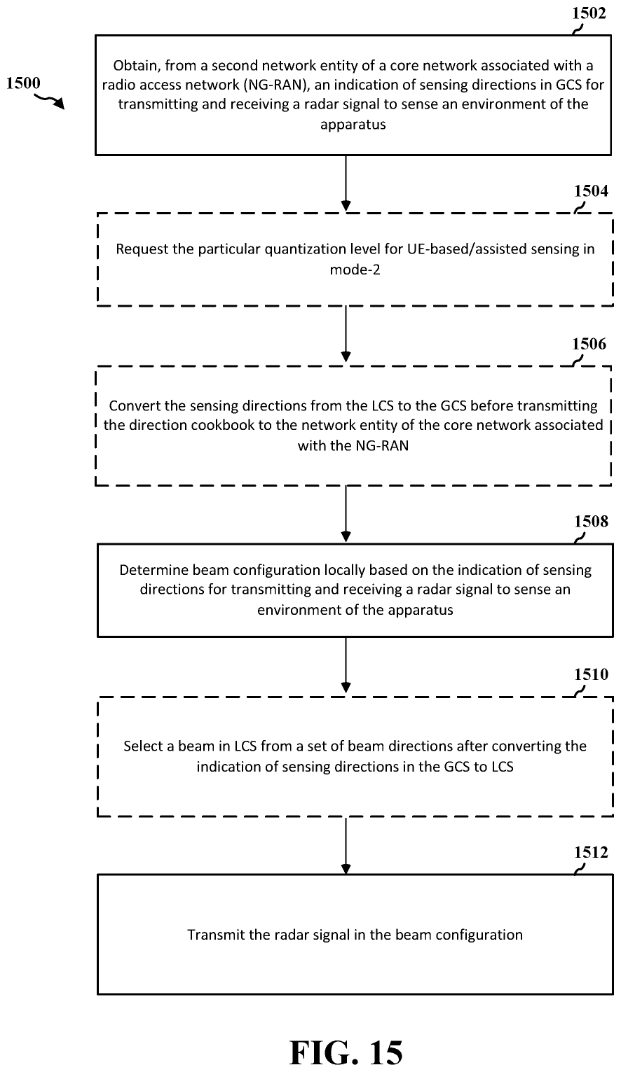

FIG. 15 is a flowchart of a method 1500 of wireless communication at a component of a radio access network. Optional aspects are illustrated in dashed lines. The method may be performed by UE-B 835. The method allows a UE to provide a sensing direction or a set of sensing directions to UEs for sensing signal transmission and/or reception.

At 1502, the method 1500 includes obtaining, from a second network entity of a core network associated with a NR-RAN, an indication of sensing directions in GCS for transmitting and receiving a radar signal to sense an environment of the apparatus. In some examples, the sensing directions are indicated using a direction cookbook with a particular quantization level.

Optionally, at 1504, the method 1500 includes requesting the particular quantization level for UE-based or UE-assisted sensing in mode-2.

Optionally, at 1506, the method 1500 includes converting the sensing directions from the LCS to the GCS before transmitting the direction cookbook to the network entity of the core network associated with the NG-RAN. In some examples, the sensing directions are converted based on additional scanning.

At 1508, the method 1500 includes determining beam configuration locally based on the indication of sensing directions for transmitting and receiving a radar signal to sense an environment of the apparatus.

Optionally, at 1510, the method 1500 includes selecting a beam in LCS from a set of beam directions after converting the indication of sensing directions in the GCS to LCS.

At 1512, the method 1500 includes transmitting the radar signal in the beam configuration.

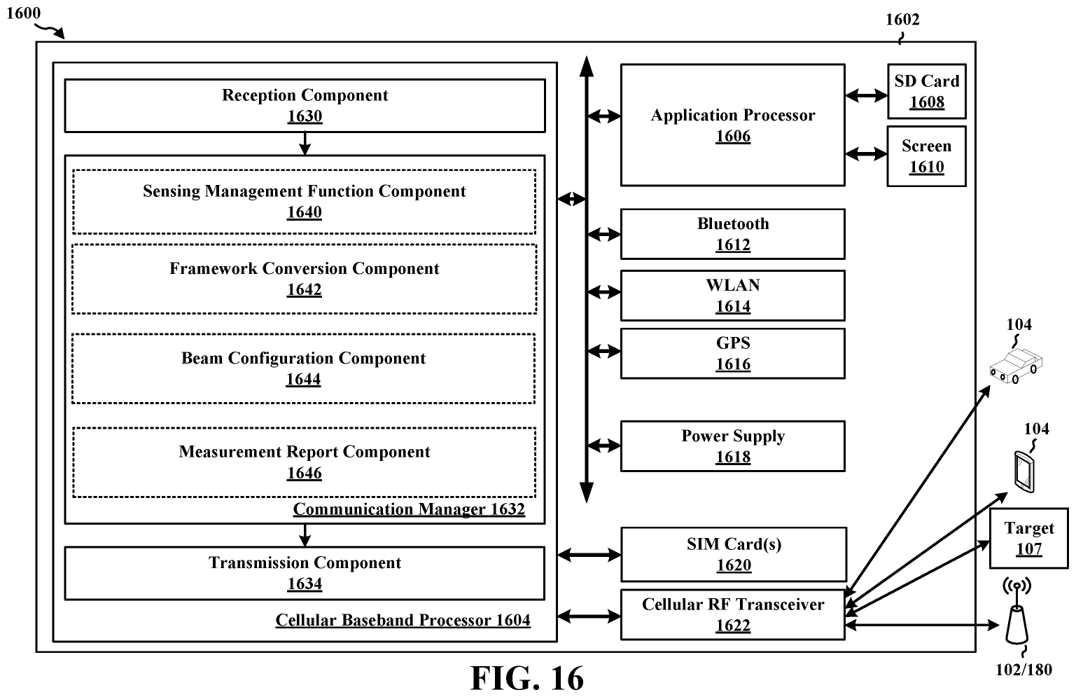

FIG. 16 is a diagram 1600 illustrating an example of a hardware implementation for an apparatus 1602. The apparatus 1602 is a UE (e.g., a Tx UE or a Rx UE), such as a VUE, and includes a cellular baseband processor 1604 (also referred to as a modem) coupled to a cellular RF transceiver 1622 and one or more subscriber identity modules (SIM) cards 1620, an application processor 1606 coupled to a secure digital (SD) card 1608 and a screen 1610, a Bluetooth module 1612, a wireless local area network (WLAN) module 1614, a Global Positioning System (GPS) module 1616, and a power supply 1618. The cellular baseband processor 1604 communicates through the cellular RF transceiver 1622 with the UE 104, which may include one or more VUEs and/or PUEs 104, target 107, and/or BS 102/180. The cellular baseband processor 1604 may include a computer-readable medium/memory. The computer-readable medium/memory may be non-transitory. The cellular baseband processor 1604 is responsible for general processing, including the execution of software stored on the computer-readable medium/memory. The software, when executed by the cellular baseband processor 1604, causes the cellular baseband processor 1604 to perform the various functions described supra. The computer-readable medium/memory may also be used for storing data that is manipulated by the cellular baseband processor 1604 when executing software. The cellular baseband processor 1604 further includes a reception component 1630, a communication manager 1632, and a transmission component 1634. The communication manager 1632 includes the one or more illustrated components. The components within the communication manager 1632 may be stored in the computer-readable medium/memory and/or configured as hardware within the cellular baseband processor 1604. The cellular baseband processor 1604 may be a component of the device 310, 350 and may include the memory 360, 376 and/or at least one of the TX processor 316, 368, the RX processor 356, 370, and the controller/processor 359, 375. In one configuration, the apparatus 1602 may be a modem chip and include just the baseband processor 1604, and in another configuration, the apparatus 1602 may be the entire device (e.g., see 310, 350 of FIG. 3) and include the aforediscussed additional modules of the apparatus 1602. The UE 104, e.g., VUE 104 (FIG. 1) may be in communication with a pedestrian UE (PUE) 104, another VUE 104, and a base station such as a gNB (102, 180).

The communication manager 1632 includes a sensing management function (SnMF) component 1640 that is configured to provide an indication of sensing directions for transmitting and receiving a radar signal to sense an environment of the apparatus e.g., as described in connection with step 1102 of FIG. 11. The SnMF component 1640 is also configured to obtain prior sensing information on target objects in locations of a sensing zone e.g., as described in connection with step 1202 of FIG. 12. The communication manager 1632 further includes a framework conversion component 1642 that is configured to determine a beam configuration in LCS, e.g., as described in connection with step 1508 of FIG. 15. The framework conversion component 1642 is further configured to obtain a GCS to LCS conversion framework, e.g., as described in connection with step 1302 of FIG. 13, and convert the sensing directions in the GCS to the LCS based on the GCS to LCS conversion framework, e.g., as described in connection with step 1304 of FIG. 13. The communication manager 1632 further includes a beam configuration component 1644 that is configured to determine configuration or change in configuration of a sensor with a set of RRS time-frequency configurations e.g., as described in connection with step 1206 of FIG. 12. The communication manager 1632 further includes a measurement report component 1646 that is configured to request sensing measurement reports, e.g., as described in connection with step 1208 of FIG. 12, and generate updated sensing measurement reports, e.g., as described in connection with step 1210 of FIG. 12.

The apparatus may include additional components that perform each of the blocks of the algorithm in the aforementioned flowcharts and timing diagrams of FIGS. 10, 11-13, and 15. As such, each block in the aforementioned flowcharts and timing diagrams of FIGS. 10, 11-13, and 15 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1602, and in particular the cellular baseband processor 1604, includes means for providing to one or more wireless nodes of a NG-RA) associated with the core network or a second network entity of the core network different from the first entity, an indication of sensing directions for transmitting and receiving a radar signal to sense an environment of the apparatus. The aforementioned means may be one or more of the aforementioned components of the apparatus 1602 configured to perform the functions recited by the aforementioned means. As described supra, the apparatus 1602 may include the TX processor 368, the RX processor 356, and the controller/processor 359. As such, in one configuration, the aforementioned means may be the TX processor 368, the RX processor 356, and the controller/processor 359 configured to perform the functions recited by the aforementioned means. Alternatively, as also described supra, the apparatus 1602 may include the TX processor 316, the RX processor 370, and the controller/processor 375. As such, in one configuration, the aforementioned means may be the TX processor 316, the RX processor 370, and the controller/processor 375 configured to perform the functions recited by the aforementioned means.

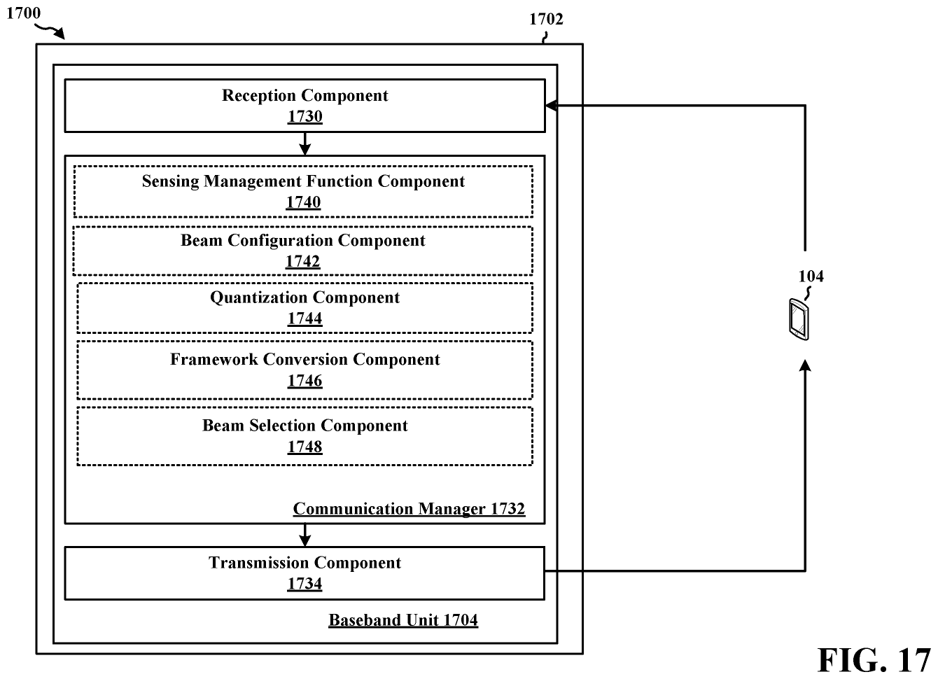

FIG. 17 is a diagram 1700 illustrating an example of a hardware implementation for an apparatus 1702. The apparatus 1702 is a base station and includes a baseband unit 1704. The baseband unit 1704 may communicate through a cellular RF transceiver with the UE 104, which may include one or more VUEs and/or PUEs. The baseband unit 1704 may include a computer-readable medium/memory. The baseband unit 1704 is responsible for general processing, including the execution of software stored on the computer-readable medium/memory. The software, when executed by the baseband unit 1704, causes the baseband unit 1704 to perform the various functions described supra. The computer-readable medium/memory may also be used for storing data that is manipulated by the baseband unit 1704 when executing software. The baseband unit 1704 further includes a reception component 1730, a communication manager 1732, and a transmission component 1734. The communication manager 1732 includes the one or more illustrated components. The components within the communication manager 1732 may be stored in the computer-readable medium/memory and/or configured as hardware within the baseband unit 1704. The baseband unit may be a component of the device 310 and may include the memory 376 and/or at least one of the TX processor 316, the RX processor 370, and the controller/processor 375.

The communication manager 1732 includes an sensing management function (SnMF) component 1740 that is configured to obtain, from a network entity of a core network associated with the radio access network (NG-RAN), an indication of sensing directions in a global coordinate system (GCS) for transmitting and receiving a radar signal to sense an environment of the apparatus, e.g., as described in connection with step 1402 of FIG. 14. The communication manager 1732 further includes a beam configuration component 1742 that is configured to determine a beam configuration in a LCS based on the indication of sensing directions in the GCS, e.g., as described in connection with step 1408 of FIG. 14. The communication manager 1732 further includes a quantization component 1744 that is configured to request a particular quantization level for network based sensing, UE-based, or UE-assisted sensing in mode-1 e.g., as described in connection with step 1404 of FIG. 14. The communications manager 1732 further includes a framework conversion component 1746 that is configured to convert the sensing directions from the LCS to the GCS before transmitting the direction cookbook to the network entity of the core network associated with the NG-RAN, e.g., as described in connection with step 1406 of FIG. 14. The communications manager 1732 further includes a beam selection component 1748 that is configured to select a beam in LCS from a set of beam directions after converting the indication of sensing directions in the GCS to LCS, e.g., as described in connection with step 1410 of FIG. 14.

The apparatus may include additional components that perform each of the blocks of the algorithm in the aforementioned flowchart and timing diagram of FIGS. 10 and 14. As such, each block in the aforementioned flowchart and timing diagram of FIGS. 10 and 14 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1702, and in particular the baseband unit 1704, includes means for obtaining, from a network entity of a core network associated with the NG-RAN, an indication of sensing directions in a GCS for transmitting and receiving a radar signal to sense an environment of the apparatus, and means for determining a beam configuration in a LCS based on the indication of sensing directions in the GCS. The aforementioned means may be one or more of the aforementioned components of the apparatus 1702 configured to perform the functions recited by the aforementioned means. As described supra, the apparatus 1502 may include the TX processor 368, the RX processor 356, and the controller/processor 359. As such, in one configuration, the aforementioned means may be the TX processor 368, the RX processor 356, and the controller/processor 359 configured to perform the functions recited by the aforementioned means. Alternatively, as also described supra, the apparatus 1702 may include the TX processor 316, the RX processor 370, and the controller/processor 375. As such, in one configuration, the aforementioned means may be the TX processor 316, the RX processor 370, and the controller/processor 375 configured to perform the functions recited by the aforementioned means.

The principles of this disclosure advantageously facilitate beam management across different types of sensing devices (UEs, VUEs, PUEs, gNBs, and/or non-3GPP radar sensors). Thus, the principles herein in large part provides key benefits by enabling key features of systems that are expected to increase in prevalence. Given that cellular networks and GPS receivers are not reliable solutions in and of themselves for localizing vehicles and pedestrians and therefore promoting safety and in due course autonomous driving, the development of other solutions is deemed paramount. Those other solutions came in part in the general form of V2X, whose specification is being promulgated in existing cellular standards, which are in use today and which may be in widespread implementation in the near future.

V2X, however, is not without its limitations when practically implemented, and it presented problems in managing how devices with different calipers of technology could merge to localize devices in a rapid yet efficient manner. Accordingly, in one aspect of the present disclosure as provided herein, critical sensing direction indication can now be readily made known to different devices in a region through a sensing management function (SnMF). Thus, SnMF in a core network can use prior sensing measurement reports to indicate sensing directions to different sensors via NG-RAN. In this way, the various aspects described throughout the present disclosure provide beam management across the different sensing devices. In this way, beam management reduces interference, reduces latency for tracking targets, and enables less resource and power usage for sensing.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B. and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. An apparatus for wireless communication at a first network entity of a core network, comprising:
one or more memories; and
one or more processors coupled with the one or more memories, and configured, individually or in combination, to cause the apparatus to:
provide, to one or more wireless nodes of a radio access network (NG-RAN) associated with the core network or a second network entity of the core network different from the first entity, an indication of sensing directions for transmitting and receiving a radar signal to sense an environment of the apparatus.

2. The apparatus of claim 1, wherein the sensing directions are indicated in a global coordinate system (GCS).

3. The apparatus of claim 2, wherein the sensing directions are further indicated using a direction cookbook with a particular quantization level.

4. The apparatus of claim 3, wherein the particular quantization level is determined by the first network entity of the core network.

5. The apparatus of claim 4 wherein the particular quantization level is coarser than a beamwidth supported by the one or more wireless nodes of the NG-RAN or the second entity of the core network provided with the indication of sensing directions.

6. The apparatus of claim 2, wherein the one or more processors are further configured, individually or in combination, to cause the apparatus to:
obtain prior sensing information on target objects in locations of a sensing zone; and
determine a beam configuration in local coordinate system (LCS) based on the obtained prior sensing information.

7. The apparatus of claim 6, wherein the one or more processors are further configured, individually or in combination, to cause the apparatus to:
obtain information on possible RRS time-frequency configurations and beam information that a sensing Tx/Rx node can support along with an optional UE capability report.

8. The apparatus of claim 7, wherein the one or more processors are further configured, individually or in combination, to cause the apparatus to:
determine configuration or change in configuration of a sensor with a set of RRS-time-frequency configurations along with sensing directions for transmitting and receiving the radar signal based on the prior sensing information, the possible RRS time-frequency configurations, and beam information.

9. The apparatus of claim 6, wherein the prior sensing information is obtained based on receiving measurement report or data.

10. The apparatus of claim 6, wherein the one or more processors are further configured, individually or in combination, to cause the apparatus to:
request sensing measurement report for sensing data from network entities of the core network at certain locations; and
generate updated sensing measurement report.

11. The apparatus of claim 1, wherein the sensing directions are provided in a local coordinate system (LCS), and wherein the one or more processors are further configured, individually or in combination, to cause the apparatus to:
obtain a global coordinate system (GCS) to LCS conversion framework; and
convert the sensing directions in the GCS to the LCS based on the GCS to LCS conversion framework, wherein the indication of sensing directions is indicated in LCS.

12. The apparatus of claim 1, wherein the first entity network comprises a sensing management function of the core network, and wherein the one or more processors are further configured, individually or in combination,
wherein the indication of sensing directions is provided from the sensing management function of the radio access network.

13. The apparatus of claim 12, wherein the sensing management function of the radio access network operates separately from a location management function of the core network to determine one or more properties of an object.

14. The apparatus of claim 12, wherein the sensing management function of the radio access network comprises a combined radio access network component that is combined with a location management component of the radio access network.

15. An apparatus for wireless communication at a component of a radio access network, comprising:
one or more memories; and
one or more processors coupled with the one or more memories, and configured, individually or in combination, to cause the apparatus to:
obtain, from a network entity of a core network associated with the radio access network (NG-RAN), an indication of sensing directions in a global coordinate system (GCS) for transmitting and receiving a radar signal to sense an environment of the apparatus; and
determine a beam configuration in a local coordinate system (LCS) based on the indication of sensing directions in the GCS.

16. The apparatus of claim 15, wherein the sensing directions are indicated using a direction cookbook with a particular quantization level.

17. The apparatus of claim 16, wherein the one or more processors are further configured, individually or in combination, to cause the apparatus to:
request the particular quantization level for network based sensing, UE-based, or UE-assisted sensing in mode-1.

18. The apparatus of claim 17, wherein the particular quantization level is coarser than a beamwidth supported by the apparatus.

19. The apparatus of claim 15, wherein the one or more processors are further configured, individually or in combination, to cause the apparatus to:
select a beam in LCS from a set of beam directions after converting the indication of sensing directions in the GCS to LCS.

20. The apparatus of claim 16, wherein the direction cookbook is informed from the network entity of a core network.

21. The apparatus of claim 20, wherein the one or more processors are further configured, individually or in combination, to cause the apparatus to:
convert the sensing directions from the LCS to the GCS before transmitting the direction cookbook to the network entity of the core network associated with the NG-RAN.

22. The apparatus of claim 21, wherein the sensing directions are converted based on additional scanning.

23. The apparatus of claim 21, wherein the sensing directions are converted randomly.

24. An apparatus for wireless communication at a first network entity of a core network, comprising:
one or more memories; and
one or more processors coupled with the one or more memories, and configured, individually or in combination, to cause the apparatus to:
obtain, from a second network entity of a core network associated with a radio access network (NG-RAN), an indication of sensing directions in GCS for transmitting and receiving a radar signal to sense an environment of the apparatus;
determine beam configuration locally based on the indication of sensing directions for transmitting and receiving a radar signal to sense an environment of the apparatus; and
transmit the radar signal in the beam configuration.

25. The apparatus for wireless communication of claim 24, wherein the sensing directions are indicated using a direction cookbook with a particular quantization level.

26. The apparatus of claim 25, wherein the one or more processors are further configured, individually or in combination, to cause the apparatus to:
request the particular quantization level for UE-based/assisted sensing in mode-2.

27. The apparatus of claim 25, wherein the one or more processors are further configured, individually or in combination, to cause the apparatus to:
select a beam in LCS from a set of beam directions after converting the indication of sensing directions in the GCS to LCS.

28. The apparatus of claim 27, wherein the one or more processors are further configured, individually or in combination, to cause the apparatus to:
convert the sensing directions from the LCS to the GCS before transmitting the direction cookbook to the network entity of the core network associated with the NG-RAN.

29. The apparatus of claim 28, wherein the sensing directions are converted based on additional scanning.

30. A method for wireless communication at a first network entity of a core network, comprising:
providing, to one or more wireless nodes of a radio access network (NG-RAN) associated with the core network or a second network entity of the core network different from the first entity, an indication of sensing directions for transmitting and receiving a radar signal to sense an environment of a sensing node.
